(19) United States
(12) Patent Application Publication
(10) Pub. No.: US 2007/0133045 A1
(43) Pub. Date: Jun. 14, 2007

(54) DATA PROCESSING APPARATUS, DATA PROCESSING METHOD, AND PROGRAM FOR IMPLEMENTING THE METHOD

(75) Inventor: Tsutomu KUBOTA, Kawasaki-shi (JP)

Correspondence Address: ROSSI, KIMMS & McDOWELL LLP., P.O. BOX 826, ASHBURN, VA, 20146-0826, US

(73) Assignee: CANON KABUSHIKI KAISHA, Tokyo (JP)

(21) Appl. No.: 11/566,805

(22) Filed: Dec. 5, 2006

(30) Foreign Application Priority Data
Dec. 12, 2005 (JP) 2005-357870

(51) Int. Cl. G06F 3/12

(52) U.S. Cl. 358/1.15

(57) ABSTRACT

A data processing apparatus which can output the same data in a plurality of different output forms according to one operating flow and therefore improve user's working efficiency. In response to an input operation by a user, an operation flow for causing an output device provided in the data processing apparatus to output the same input data in at least two different output forms is created. At least one operation flow thus created is registered. An operation flow designated by the user from among the registered operation flows is selected and then set for the output device.

### BACKGROUND OF THE INVENTION

1. Field of the Invention

The present invention relates to a data processing apparatus including an output device capable of outputting the same input data in a plurality of different output forms, a data processing method, and a program for implementing the method.

2. Description of the Related Art

Conventionally there have been workflow systems which are comprised of a multi-function peripheral (hereinafter referred to as “MFP” having a plurality of functions such as a printer function, a facsimile function, and a scanner function, as well as a computer connected to the MFP (see Japanese Laid-Open Patent Publication (Kokai) No. 2004-295695, for example). In such workflow systems, a flow for causing the MFP to perform its plurality of functions in combination so as to produce printed output suitable for predetermined work is specified in advance. The computer controls the MFP according to the specified flow, so that the MFP performs operations according to the specified flow.

In the above workflow systems, if, for example, a flow is specified such that an image on an original is to be read using the scanner function and printed out with a page layout of “1in1”, it is possible to carry out operations according to this flow. Thus, flows which support routine work can be set with ease.

However, if the user intends to print the same image data with a page layout of “2in1” as well as the page layout of “1in1”, it is necessary to additionally create a flow for printing out the image data with the page layout of “2in1. ” Also, it is necessary to separately carry out the flow in which the image data is printed with the page layout of “1in1” and the flow in which the image data is printed with the page layout of “2in1.”

As explained above, there may be cases where input data cannot be outputted in a plurality of output forms desired by the user in one flow, and user's working efficiency cannot be satisfactory.

### SUMMARY OF THE INVENTION

It is an object of the present invention to provide a data processing apparatus and a data processing method which can output the same data in a plurality of different output forms according to one operation flow and therefore improve user's working efficiency, as well as a program for implementing the method.

To attain the above object, in a first aspect of the present invention, there is provided a data processing apparatus including an output device capable of outputting the same input data in a plurality of different output forms, comprising a creating device that creates an operation flow for causing the output device to operate in such a manner as to output the same input data in at least two different output forms, in response to an input operation by a user, a registering device that registers at least one operation flow created by the creating device, a selecting device that selects an operation flow designated by the user from among the operation flows registered in the registering device, and a setting device that sets the operation flow selected by the selecting device for the output device.

Preferably, a data processing apparatus according comprises a display device that displays an operation flow creation operating screen capable of receiving input operations by a user.

Preferably, the output device comprises at least one printing device, and operation flows that can be created for the output device include an operation flow that outputs the same input data in at least two different output forms.

Preferably, the output device comprises a printing device and at least one data processing section, and operation flows that can be created for the output device include an operation flow including an operation in which the same input data is outputted in at least two different output forms by the printing device and an operation in which the same input data is processed by the data processing section.

To attain the above object, in a second aspect of the present invention, there is provided a data processing method applied to a data processing apparatus including an output device capable of outputting the same input data in a plurality of different output forms, comprising a creating step of creating an operation flow for causing the output device to operate in such a manner as to output the same input data in at least two different output forms, in response to an input operation by a user, a registering step of registering at least one operation flow created in the creating step, a selecting step of selecting an operation flow designated by the user from among the operation flows registered in the registering step, and a setting step of setting the operation flow selected in the selecting step for the output device.

To attain the above object, in a third aspect of the present invention, there is provided a program for causing a computer to execute a data processing method applied to a data processing apparatus including an output device capable of outputting the same input data in a plurality of different output forms, the program comprising a creating module for creating an operation flow for causing the output device to operate in such a manner as to output the same input data in at least two different output forms, in response to an input operation by a user, a registering module for registering at least one operation flow created by the creating module, a selecting module for selecting an operation flow designated by the user from among the operation flows registered by the registering module, a setting module for setting the operation flow selected by the selecting module for the output device.

According to the present invention, the same data can be outputted in a plurality of different output forms according to one operation flow, thereby improving user's working efficiency.

The above and other objects, features, and advantages of the invention will become more apparent from the following detailed description taken in conjunction with the accompanying drawings.

### BRIEF DESCRIPTION OF THE DRAWINGS

FIG. 1 is a block diagram showing the construction of an MFP (Multi Function Printer) constituting a data processing apparatus according to a first embodiment of the present invention.

FIG. 2 is a view showing an example of the layout of an operating screen displayed on a panel section in creating and registering an operating flow.

FIG. 3 is a view showing an example of the screen in the case where a new flow is added to flows displayed on the screen in FIG. 2.

FIG. 4 is a view showing an example of the screen in a state in which functions have been set for the flows on the screen in FIG. 3.

FIG. 5 is a view showing a scanning function advanced settings screen for making advanced settings of a scanning function in Flow 1.

FIG. 6 is a view showing a printing function advanced settings screen for making advanced settings of a printing function in Flow 2.

FIG. 7 is a view showing a sending function advanced settings screen for making advanced settings of a sending function in Flow 2.

FIG. 8 is a view showing a printing function advanced settings screen for making advanced settings of a printing function in Flow 3.

FIG. 9 is a view showing a box function advanced settings screen for making advanced settings of a box function in Flow 3.

FIG. 10 is a view showing a flow registration screen.

FIG. 11 is a view showing a main screen displayed on the panel section.

FIG. 12 is a view showing a flow call screen displayed on the panel section in calling an operation flow.

FIG. 13 is a view showing a screen on which an operation flow called through operation on the flow call screen in FIG. 12 is displayed.

FIG. 14 is a flow chart showing the procedure of a process carried out by an MFP connected to a host computer constituting a data processing apparatus according to a second embodiment of the present invention.

### DETAILED DESCRIPTION OF THE PREFERRED EMBODIMENTS

The present invention will now be described in detail with reference to the drawings showing preferred embodiments thereof.

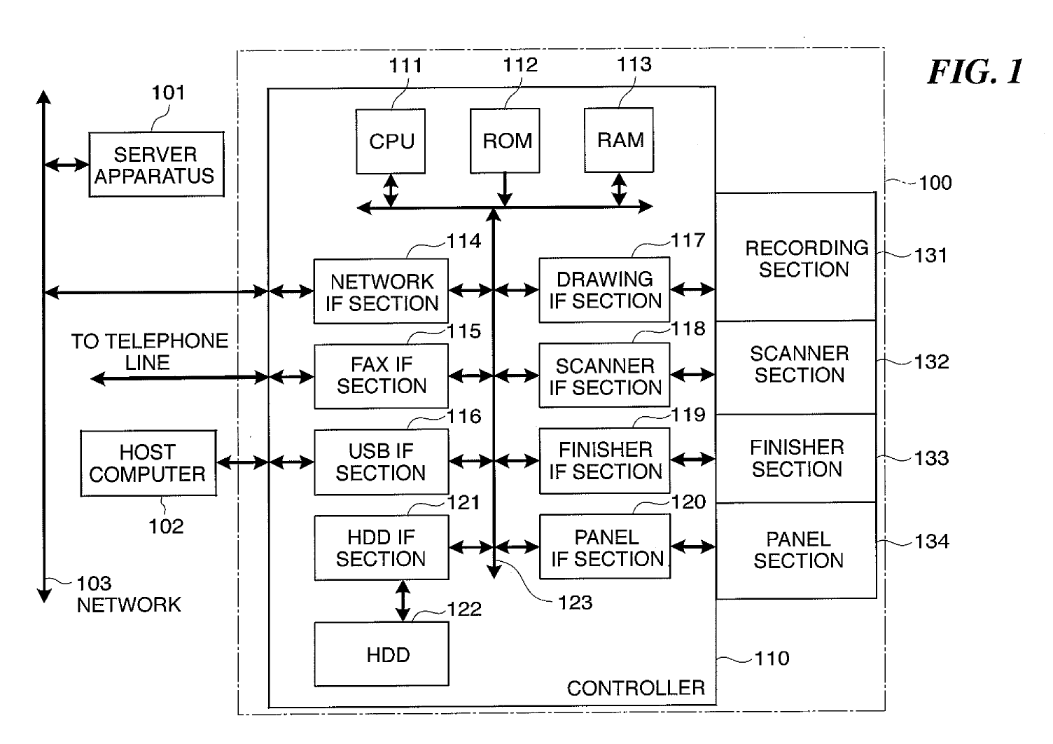

FIG. 1 is a block diagram showing the construction of an MEP (Multi Function Printer) constituting a data processing apparatus according to a first embodiment of the present invention.

As shown in FIG. 1, the MFP 100 is comprised of a controller 110, a recording section 131, a scanner section 132, a finisher section 133, and a panel section 134. The controller 110 controls the entire MFP 100. The recording section 131 prints out images based on data on sheets. The recording section 131 is implemented, for example, by a laser-beam or inkjet printer. The recording section 131 is also equipped with a plurality of sheet-feed cassettes so that sheets of different sizes can be selected as sheets for printout. The scanner section 132 has a mode for reading one side of an original and a mode for reading both sides of an original and outputs data read in these modes. The finisher section 133 performs sheet processing on sheets outputted from the recording section 131. The panel section 134 is provided with various hard keys and a liquid crystal display panel, on which, for example, an operating screen including soft keys for setting of modes, input of data, and so forth are displayed. Also, on the panel section 134, the status of the apparatus is displayed, and operation settings are made by the user.

The controller 110 includes a CPU 111. The CPU 111 controls the entire apparatus including the recording section 131, scanner section 132, finisher section 133, and panel section 134 by reading programs stored in a ROM 112 or an HDD 122 into a RAM 113 and executing the programs. The RAM 113 provides a working area for operation of the CPU 111 and an area for temporarily storing data. The ROM 112, RAM 113, and various IF (interface) sections are connected to the CPU 111 via a bus 123. The IF sections include a network IF section 114, a FAX IF section 115, a USB IF section 116, a drawing IF section 117, a scanner IF section 118, a finisher IF section 119, a panel IF section 120, and an HDD IF section 121.

The network IF section 114 is an interface for carrying out transmission and reception of data via a network 103. The FAX IF section 115 is an interface for carrying out transmission and reception of facsimile data via a telephone line. The USB IF section 116 is an interface for carrying out transmission and reception of data to and from a host computer 102. The drawing IF section 117 is an interface for carrying out communication with the recording section 131 and transmitting graphic data (video data) to the recording section 131 in synchronized manner. The scanner IF section 118 is an interface for carrying out communication with the scanner section 132. The finisher IF section 119 is an interface for carrying out communication with the finisher section 133. The panel IF section 120 is an interface for carrying out communication with the panel section 134. The HDD IF section 121 is an interface for carrying out communication with an HDD 122.

A server apparatus 101 is connected to the network 103. The server apparatus 101 and the MFP 100 can input and output data to and from each other via the network 103. The host computer 102 outputs print data to the MFP 100.

With the above described arrangement, the MFP 100 realizes a plurality of functions. Specifically, the MFP 100 realizes a printing function using the recording section 131, a scanning function using the scanner section 132, and a sheet processing function using the finisher section 133. The MFP 100 also realizes a facsimile transmitting/receiving function using the scanner section 132 and the recording section 131, a copying function using the scanner section 132 and the recording section 131, and a box function using the HDD 122.

In the present embodiment, it is possible to create and register an operation flow according to which a sequence of operations is carried out using a combination of functions. According to each registered operation flow, a sequence of operations included therein can be carried out. Examples of functions that can be combined for operation flows include a scanning function, a data creating function, a printing function, a sending function, a facsimile transmitting function, and a box function. The scanning function is a function of reading an image on an original using the scanner section 132 and outputting the obtained data. The data creating function is a function of receiving print data from an external apparatus, i.e. the host computer 102 in the present embodiment, to create data such as a bitmap. The printing function is a function of causing the recording section 131 to print out data inputted using the scanning function or the data creating function. The sending function is a function of converting designated data into predetermined data format (for example, PDF format) and transmitting the resultant data to a designated e-mail address via the network 103. The facsimile transmitting function is a function of transmitting data, which has been inputted using the scanning function or the data creating function, as facsimile data via a telephone line. The box function is a function of converting data, which has been inputted using the scanning function or the data creating function, into designated data format (for example, JPEG format) and storing the resultant data in the HDD 122. It should be noted that data stored in the HDD 122 using the box function can thereafter be subjected to processing using the printing function, sending function, and facsimile transmitting function.

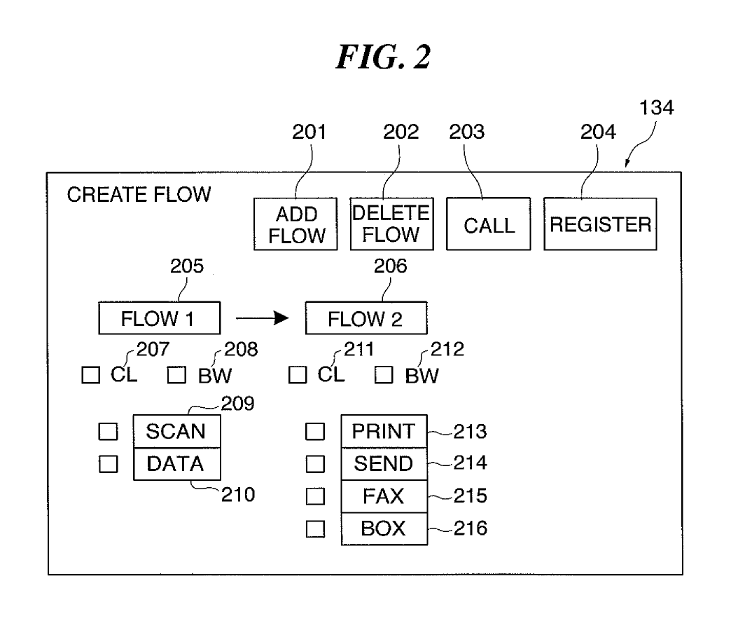

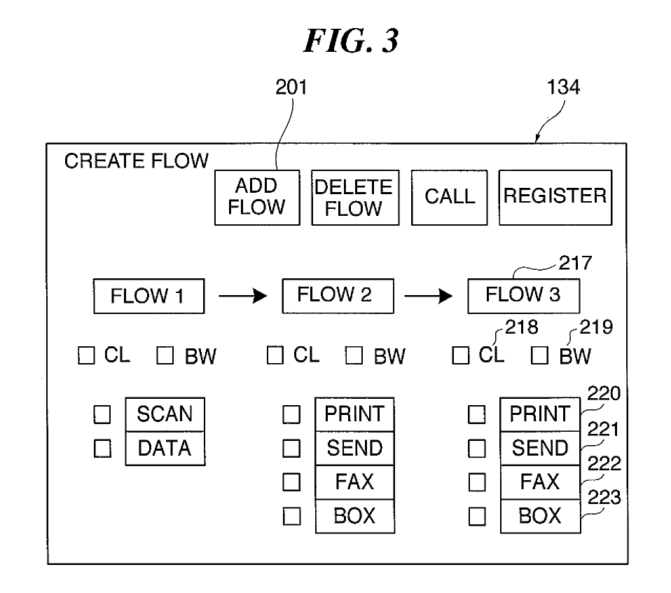

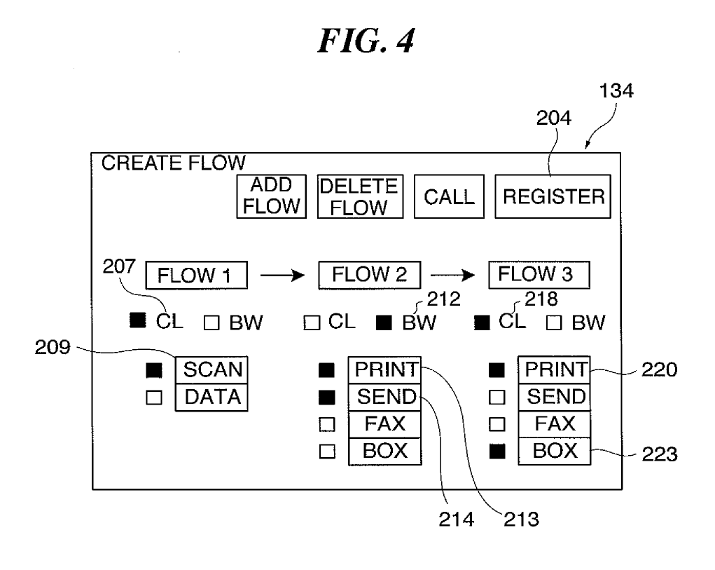

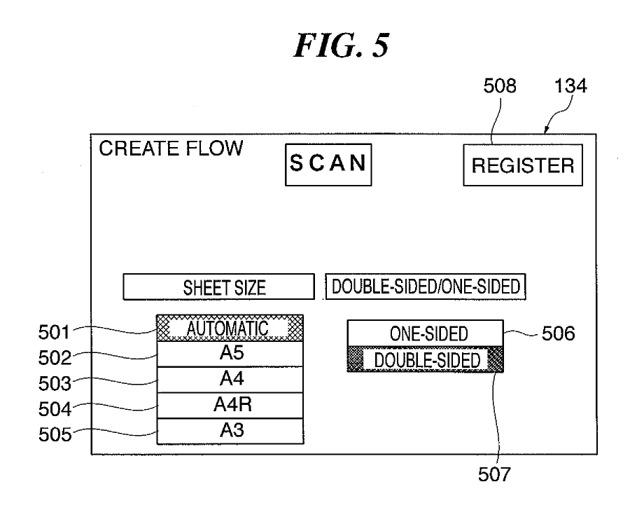

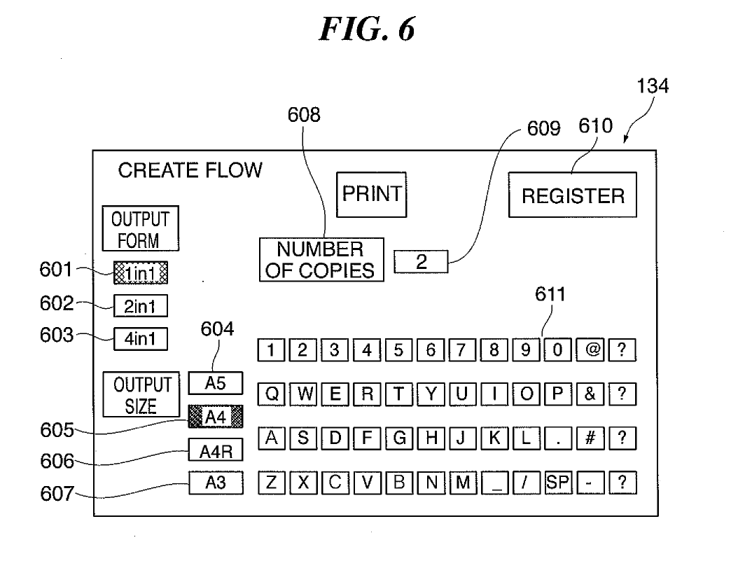

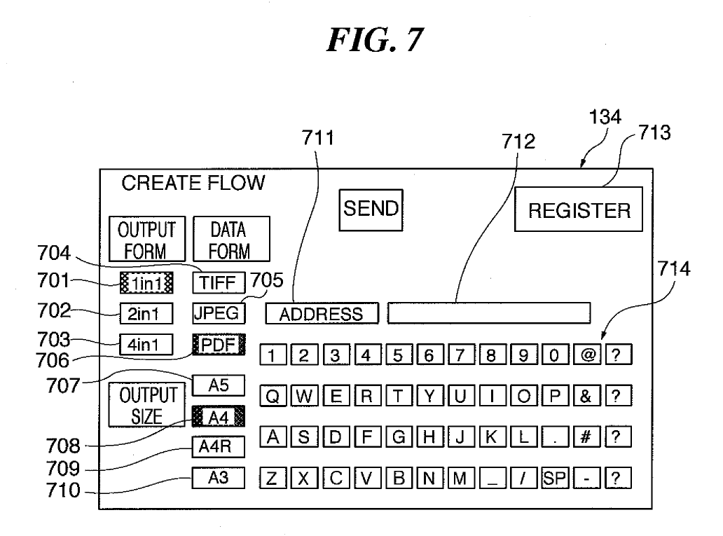

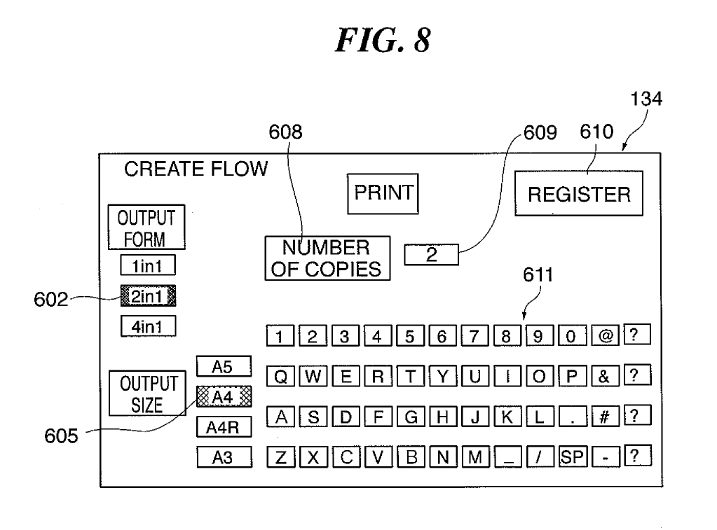

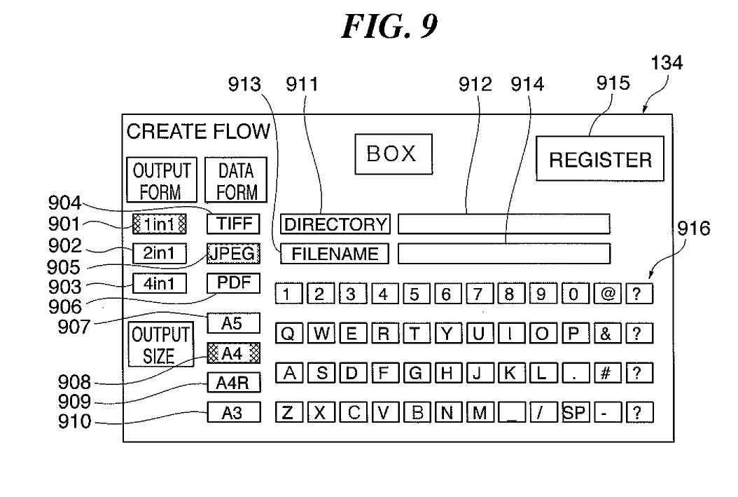

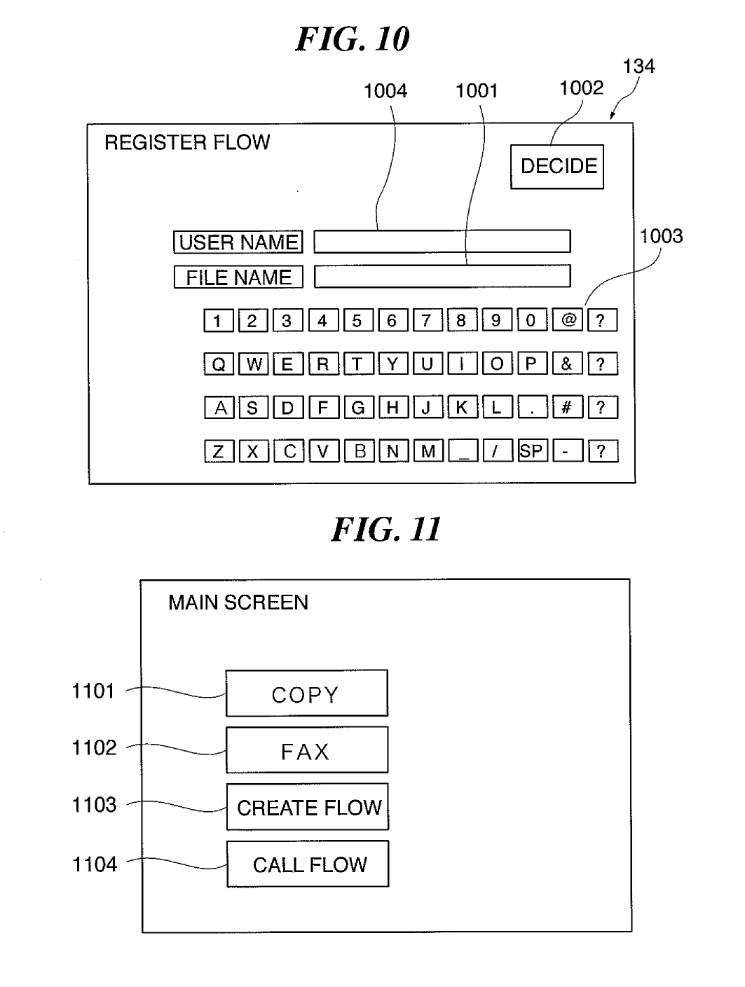

Referring first to FIGS. 2 to 11, a description will be given of how an operation flow is created and registered. FIG. 2 is a view showing an example of an operating screen displayed on the panel section in creating and registering an operation flow. FIG. 3 is a view showing an example of the screen in the case where a new flow has been added to flows displayed on the screen in FIG. 2. FIG. 4 is a view showing an example of the screen in a state in which functions have been set for the flows on the screen in FIG. 3. FIG. 5 is a view showing a scanning function advanced settings screen for making advanced settings of the scanning function in Flow 1. FIG. 6 is a view showing a printing function advanced settings screen for making advanced settings of the printing function in Flow 2. FIG. 7 is a view showing a sending function advanced settings screen for making advanced settings of the sending function in Flow 3. FIG. 8 is a view showing a printing function advanced settings screen for making advanced settings of the printing function in Flow 3. FIG. 9 is a view showing a box function advanced settings screen for making advanced settings of the box function in Flow 3. FIG. 10 is a view showing a flow registration screen. FIG. 11 is a view showing a main screen displayed on the panel section.

Operations for creating and registering an operation flow are carried out on an operation screen displayed on the panel section 134 as shown in FIG. 1. In the description of the present embodiment, it is assumed that an operation flow with a combination of the scanning function, data creating function, printing function, sending function, facsimile transmitting function, and box function is created.

A main screen as shown in FIG. 11, for example, is displayed on the panel section 134. On this main screen, a copy key (COPY) 1101 for selecting the copying function, a FAX key 1102 for selecting the facsimile function, a flow creation key 1103, and a flow call key 1104, which are touch-sensitive keys, are displayed. When the user depresses the flow creation key 1103, an operating screen as shown in FIG. 2 is displayed on the panel section 134 so as to create an operation flow. On the screen shown in FIG. 2, icons 205 and 206 corresponding to Flow 1 and Flow 2, respectively, and operation designation keys for designating operations to be carried out in Flows 1 and 2 are displayed in association with each other.

Flow 1 is a flow that specifies operations for inputting data. For Flow 1, either the scanning function or the data creating function can be selected, and a SCAN key 209 and a DATA key 210 are displayed in association with the icon 205 of Flow 1. The SCAN key 209 and the DATA key 210 are selectable exclusively of each other, and they cannot be selected at the same time. Checkboxes are displayed on the left side of the SCAN key 209 and the DATA key 210 so as to indicate that they are selected. Also, a CL key 207 and a BW key 208 for determining whether or not an image is to be read in color or black-and-white are displayed. The CL key 207 and the BW key 208 are selectable exclusively of each other, and they cannot be selected at the same time. Checkboxes are displayed on the left side of the CL key 207 and the BW key 208 so as to indicate that they are selected.

Flow 2 is a flow that specifies operations for outputting data. Specifically, Flow 2 specifies whether data inputted through operation of Flow 1 is to be printed in color or black and white, transmitted by e-mail or not, transmitted by facsimile or not, and stored in the HDD 122 or not. To select operations in Flow 2, a CL key 211, a BW key 212, a PRINT key 213, a SEND key 214, a FAX key 215, and a BOX key 216 are displayed in association with the icon 206 of Flow 2. The PRINT key 213 is a key for selecting the printing function. The SEND key 214 is a key for selecting the sending function. The FAX key 215 is a key for selecting the facsimile transmitting function. The BOX key 216 is a key for selecting the box function. The CL key 211 and the BW key 212 are keys for determining whether or not an image is to be printed in color or black and white. Checkboxes are displayed on the left sides of the respective keys 211 to 216 so as to indicate that they are selected.

On the screen shown in FIG. 2, a flow addition key 201, a flow deletion key 202, a call key 203, and a registration key 204 are also displayed. The flow addition key 201 is a key for adding a new flow to flows displayed on the screen shown in FIG. 2. The flow deletion key 202 is a key for deleting at least part of displayed flows. The call key 203 is a key for calling registered operation flows. The registration key 204 is a key for registering created operation flows.

When the user depresses the flow addition key 201 on the screen shown in FIG. 2, an icon 217 of Flow 3 to be added is displayed on the screen as shown in FIG. 3. Flow 3 to be added is a flow that specifies operations for outputting data. Specifically, Flow 3 specifies whether data read through operations in Flow 1 is to be printed in color or black and white, transmitted by e-mail or not, transmitted by facsimile or not, and stored in the HDD 122 or not. To select operations in Flow 3, a CL key 218, a BW key 219, a PRINT key 220, a SEND key 221, a FAX key 222, and a BOX key 223 are displayed in association with the icon 217 of Flow 3. Checkboxes are displayed on the left sides of the respective keys 218 to 223 so as to indicate that they are selected. The keys 218 to 223 are intended to make settings as those made by the respective keys 211 to 216 for Flow 2.

Here, it is assumed that an operation flow for reading both sides of an original in color, printing the read data, transmitting the data by e-mail, and storing the data in the HDD 122 is created. Also, it is assumed that as for printing, it is determined that two copies of black-and-white printed output with a page layout of “1in1” are to be produced, and two copies of color printed output with a page layout of “2in1” are to be produced.

In creating the above operation flow, appropriate keys are depressed so as to designate operations in Flows 1, 2, and 3. As for Flow 1, to specify that both sides of an original in color are to be read, the SCAN key 209 is depressed, and the checkbox on the left side thereof is marked (i.e. the checkbox is displayed in black). Also, the CL key 207 is depressed, and the checkbox on the left side thereof is marked (i.e. the checkbox is displayed in black). In the case where the CL key 207 is depressed, the checkbox for the BW key 208 is unmarked (i.e. the checkbox is displayed in white). When the CL key 207 is depressed with the checkbox for the CL key 207 marked, the checkbox for the CL key 207 is cleared.

Upon depression of the SCAN key 209 such as double-click, a scanning function advanced settings screen as shown in FIG. 5 is displayed on the panel section 134. On this scanning function advanced settings screen, a plurality of sheet size selection keys (automatic, A5, A4, . . . ) 501 to 505 are displayed. The size of an original to be read can be designated by depressing any of the sheet size selection keys 501 to 505. The sheet size selection keys 501 to 505 are inverted from white to black when they are selected. In the illustrated example, the automatic key 501 for automatically determining the size of an original to be read is selected and displayed in black. Also, a one-side key 506 for selecting one-sided reading and a double-side key 507 for selecting double-sided reading are displayed. The one-side key 506 and the double side key 507 are inverted from black to white and vice versa. In this example, the double-side key 507 is selected.

When the advanced settings of the scanning function are completed, a registration key 508 on the scanning function advanced settings screen is depressed. As a consequence, the display switches to the screen shown in FIG. 4 while maintaining the settings.

As for Flow 2 the PRINT key 213 and the SEND key 214 are depressed so as to specify that two copies of printed output with a page layout of “1in1” are to be produced from data read through operations in Flow 1 and the data is to be also transmitted by e-mail. Responsive to this, the checkboxes for the PRINT key 213 and the SEND key 214 are marked. Also, to select black-and-white printing, the BW key 212 is depressed and the checkbox therefor is marked.

Also, to make advanced settings of the printing function, the user double-clicks on the PRINT key 213, causing a printing function advanced settings screen shown in FIG. 6 to be displayed on the panel section 134.

On this printing function advanced settings screen, a plurality of output form selection keys 601 to 603 for selecting the output form are displayed. Any desired one of output forms “1in1”, “2in1”, and “4in1” can be selected by depressing an associated one of the output form selection keys 601 to 603. The output form selection keys 601 to 603 are inverted from white to black when they are selected. In the illustrated example, the output form selection key 601 is depressed to select the output form “1in1.”

Also, a plurality of output size selection keys 604 to 607 for selecting the output size are displayed on the printing function advanced settings screen. Any desired one of output sizes “A5”, “A4”, “A4R”, and “A3” can be selected by depressing an associated one of the output size selection keys 604 to 607. The output size selection keys 604 to 607 are inverted from white to black when they are selected. In the illustrated example, the output size selection key 605 is depressed to select the output size “A4.”

Also, a number-of-copies key 608 for designating the entry of the number of copies and a number-of-copies entry box 609 are displayed. When the number-of-copies key 608 is depressed, the entry of the number of copies into the number-of-copies entry box 609 is permitted. Displayed keys 611 including alphabetic character keys and numeric keys are then operated to enter the number of copies into the number-of-copies entry box 609. In the illustrated example, “2” is entered as the number of copies.

When the advanced settings of the printing function are completed in the above described manner, a registration key 610 on the printing function advanced settings screen is depressed. As a consequence, the display switches to the screen shown in FIG. 4 while maintaining the settings.

To make advanced settings of the sending function, the user double-clicks on the SEND key 214 on the screen shown in FIG. 4, causing a sending function advanced settings screen as shown in FIG. 7 to be displayed on the panel section 134.

On this sending function advanced settings screen, a plurality of output form selection keys 701 to 703 for selecting the output form are displayed. Any desired one of output forms “1in1”, “2in1”, and “4in1” can be selected by depressing an associated one of the output form selection keys 701 to 703. The output form selection keys 701 to 703 are inverted from white to black when they are selected. In the illustrated example, the output form selection key 701 is depressed to select the output form “1in1.”

Also, a plurality of output data form selection keys 704 to 706 for selecting the output data form are displayed on the sending function advanced settings screen. Any desired one of output data forms “TIFF”, “JPEG”, and “PDF” can be selected by depressing an associated one of the output data form selection keys 704 to 706. The output data form selection keys 704 to 706 are inverted from white to black when they are selected. In the illustrated example, the output data form selection key 706 is depressed to select the output data form “PDF.”

Also, a plurality of output size selection keys 707 to 710 for selecting the output size are displayed on the printing function advanced settings screen. Any desired one of output sizes “A5”, “A4”, “A4R”, and “A3” can be selected by depressing an associated one of the output size selection keys 707 to 710. The output size selection keys 707 to 710 are inverted from white to black when they are selected. In the illustrated example, the output size selection key 708 is depressed to select the output size “A4.”

Also, an address key 711 for designating the entry of a destination address and an address entry box 712 for entry of address information are displayed. When the address key 711 is depressed, the entry of address information into the address entry box 712 is permitted. Displayed keys 714 including alphabetic character keys and numeric keys are then operated to enter desired address information into the address entry box 712. It should be noted that an address can be entered not only by using the displayed keys 714 but also by selecting from an address book, not shown, stored in the MFP 100.

When the advanced settings of the sending function are completed in the above described manner, a registration key 713 on the sending function advanced settings screen is depressed. As a consequence, the display switches to the screen shown in FIG. 4 while maintaining the settings.

As for Flow 3, the PRINT key 220 and the BOX key 223 are depressed so as to specify that two color copies of printed output with the page layout “2in1”are to be produced from data read through operations in Flow 1 and the data is to be stored in the HDD 122. Responsive to this, the checkboxes for the PRINT key 220 and the BOX key 223 are marked. Also, to select color printing, the CL key 218 is depressed, and the checkbox therefor is marked.

Also, to make advanced settings of the printing function, the user double-clicks on the PRINT key 220, causing a printing function advanced settings screen shown in FIG. 8 to be displayed on the panel section 134. This printing function advanced settings screen is the same as that in FIG. 6. In the illustrated example, the output form selection key 602 is depressed to select the output form “2in1.” Also, the output size selection key 605 is depressed to select the output size “A4.” Also, “2” is entered as the number of copies into the number-of-copies box 609 by operating the numeric keys of the keys 611.

When the advanced settings of the printing function are completed in the above described manner, the registration key 610 on the printing function advanced settings screen is depressed. As a consequence, the display switches to the screen shown in FIG. 4 while maintaining the settings.

To make advanced settings of the box function, the user double-clicks on the BOX 223 on the screen shown in FIG. 4, causing a box function advanced settings screen as shown in FIG. 9 to be displayed on the panel section 134. On this box function advanced settings screen, a plurality of output form selection keys 901 to 903, a plurality of output data form selection keys 904 to 906, and a plurality of output size selection keys 907 to 910 are displayed as is the case with the sending function advanced settings screen shown in FIG. 7.

Also, a directory key 911 for designating the entry of a directory in which data is to be stored and a directory entry box 912 for entry of directory information are displayed on the box function advanced settings screen. When the directory key 911 is depressed, the entry of directory information into the directory input box 912 is permitted. Displayed Keys 916 including alphabetic character keys and numeric keys, are then operated to enter desired address information into the directory entry box 912. In the illustrated example, the output form “1in1”, the output data form “JPEG”, and the output size “A4” are selected.

A file name key 913 for designating the entry of a file name and a file name entry box 914 are displayed on the box function advanced settings screen. When the file name key 913 is depressed, the entry of directory information into the directory input box 914 is permitted. The displayed keys 916 including alphabetic character keys and numeric keys are then operated to enter a desired file name into the directory entry box 914.

When the advanced settings of the box function are completed in the above described manner, a registration key 915 on the box function advanced settings screen is depressed. As a consequence, the display switches to the screen shown in FIG. 4 while maintaining the settings.

When the registration key 204 is depressed on the screen shown in FIG. 4 after the advanced settings of the functions in Flows 1, 2, and 3 are completed, a flow registration screen shown in FIG. 10 is displayed on the panel section 134. This flow registration screen is a screen for registering created operation flows in the form of files (files in which control information for the operation flows is described). On the flow registration screen, a file name entry box 1001, a decision key 1002, keys 1003, and a user name entry box 1004 are displayed. A desired file name is entered into the file name entry box 1001 by operating alphabetic character keys and numeric keys of the keys 1003. A desired user name is entered into the user name entry box 1004 by operating alphabetic character keys and numeric keys of the keys 1003. Whether to enter a user name into the user name entry box 1004 may be arbitrarily determined, and a user name should not necessarily be entered. In the case where a user name is entered, MFP 100 carries out management of the user name in association with the entered file name. It should be noted that a user name is only an example of identification information for identifying a user, and any arbitrary information other than a user name may be used as such identification information. When the decision key 1002 is depressed after the entry of the file name, the operation flow is stored with the entered file name in a specific directory in the HDD 122. The display then switches to a screen shown in FIG. 11.

It should be noted that in the present embodiment, on the advanced settings screen for the scanning function, data creating function, printing function, and so forth (FIGS. 5 to 9), an operation flows may be registered even in a state in which advanced settings of each function have not yet been made. For example, in the case where the sending function is registered for an operation flow, the data form and the output form may be registered in advance, and only a destination address may be entered in carrying out the operation flow. This is effective for users who intend to determine only forms such as data forms but do not intend to determine a transmission address in advance. That is, if any of the functions shown in FIG. 4 is selected, an operation flow may be registered.

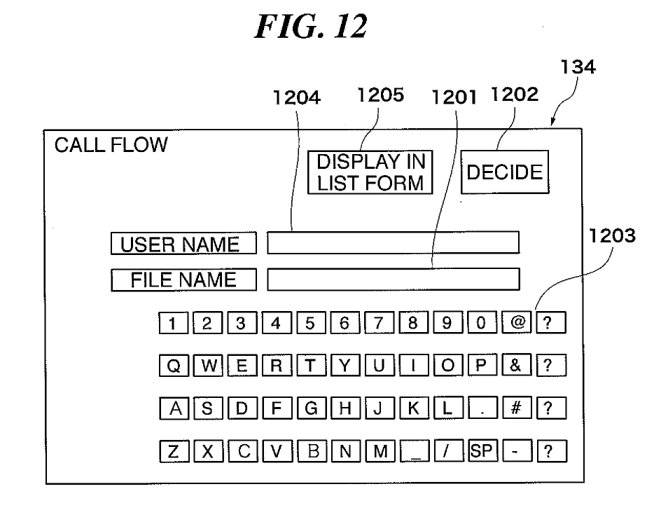

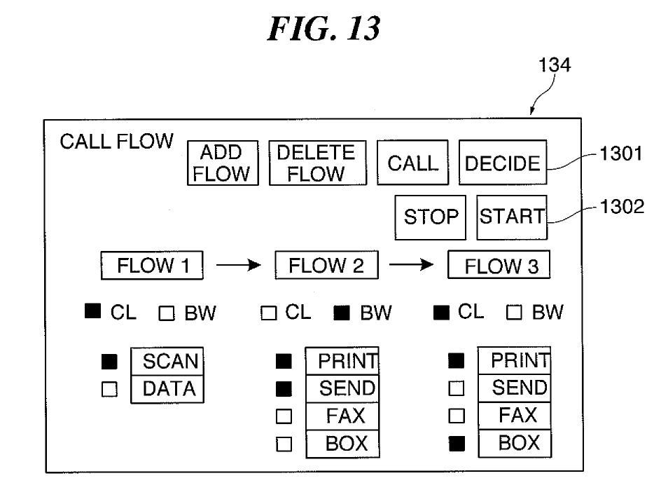

Referring next to FIGS. 12 and 13, a description will be given of a procedure for calling registered operation flows (files in which control information for the operation flows is described). FIG. 12 is a view showing a flow call screen displayed on the panel section in calling an operation flow or operation flows. FIG. 13 is a view showing a screen on which an operation flow called through operation on the flow call screen in FIG. 12 is displayed.

When a flow call key 1104 is depressed on the main screen shown in FIG. 11, the flow call screen shown in FIG. 12 is displayed on the panel section 134. The flow call screen is a screen for calling a registered operation flow or registered operation flows (file(s) in which control information for the operation flow(s) is described). A file name entry box 1201, a decision key 1202, keys 1203, a user name entry box 1204, and a list display key 1205 are displayed on the flow call screen. Methods for the user to designate a file name will now be described. One is a method in which a file name is directly entered into the file name entry box 1204 by operating alphabetic character keys and numeric keys of the keys 1203. In this method, it is necessary for the user to remember a file name of an operation flow to be called. Another one is a method in which the user depresses the display list key 1205 to display a list of files names of operation flows registered in the MFP 100. In this method, a file name selected from the displayed list affects the file name entry box 1201. Another one is a method in which the user enters a user name into the user name entry box 1204, depresses the list key 1205 to display a list of only file names registered in association with the entered user name in the MFP 100. In this method, the user can search for a desired operation flow from among operation flows associated with his/her user name, not from among all the operation flows registered in the MFP 100. Another one is a method in which file names of operation flows (files) stored in a specific directory of the HDD 122 are sequentially displayed in the file name entry box 1201 by operating a cursor key of the keys 1203. When the decision key 1202 is depressed with a desired file name being displayed in the file name entry box 1201 using any of the above described methods, an operation flow corresponding to the file name are called from a specific directory of the HDD 122. The display then switches to a screen shown in FIG. 13. On this screen, information indicative of the contents of the read operation flow is displayed. The displayed operation flow is the same as the operation flow displayed on the screen shown in FIG. 4.

Here, if any of functions in the operation flow called by the user includes items for which settings have not yet been made, keys, for example, corresponding to the functions including the items for which settings have not yet been made are blinked. This informs the user of the functions including the items for which settings have not yet been made and prompts the user to make settings for the concerned items. In this case, the user double-clicks on the key for the corresponding function to display an associated advanced settings screen. On this advanced settings screen, settings for the concerned items are made by performing the same operation as the operation for creating an operation flow. For example, if a transmission address has not been set with the sending function selected, the SEND key for Flow 2 is blinked on the screen shown in FIG. 13.

When the decision key 1301 is depressed on the screen shown in FIG. 13, the MFP 100 configures such that the called operation flow can be carried out and waits for an instruction to start carrying out the operation flow.

Next, a description will be given of the procedure of a process in which the MFP 100 carries out operations according to the called operation flow. It is assumed here that the operation flow shown in FIG. 13 is called and carried out.

In calling and carrying out the operation flow using the above mentioned procedure, the user places a printout such as an original to be processed on the scanner section 132 and depresses a “START” key 1302 on the panel section 134. By depressing the “START” key 1302, an instruction to start carrying out the called operation flow is given to the CPU 111. Responsive to this instruction, the CPU 111 provides controls first to carry out operations according to Flow 1. In the present embodiment, both sides of the printout are read in color using the scanner section 132, and the read data is transferred to the RAM 113 via the scanner IF section 118.

The CPU 111 then provides control to carry out operations according to Flow 2. Here, the printing function creates black-and-white print data for the output form “1in1” based on the data held in the RAM 113 and outputs the black-and-white print data to the recording section 131 via the drawing IF section 117. The recording section 131 produces two copies of black-and-white printed output in the output form “1in1.” The sending function converts the data held in the RAM 113 into PDF data and holds the PDF data in the RAM 113. The PDF data is attached to an electronic mail which is to be transmitted to a designated address, and this electronic mail is transmitted via the network IF section 114.

The CPU 111 then provides control to carry out operations according to Flow 3. Here, the printing function creates color print data for the output form “2in1” based on the data held in the RAM 113 and outputs the color print data to the recording section 131 via the drawing IF section 117. The recording section 131 produces two copies of color printed output in the output form of “2in1.” The box function converts the data held in the RAM 113 into JPEG data and holds the JPEG data in the RAM 113. The JPEG data is stored with a designated file name in a designated directory of the HDD 122 via the HDD IF section 121.

Although in the present embodiment, the operation flow for reading both sides of an original (a printout) in color, printing the read data, transmitting the data by e-mail, and storing the data in the HDD 122 is illustrated by way of example, the present invention is not limited to this. It is possible to create a variety of operation flows with combinations of the scanning function, data creating function, printing function, sending function, facsimile transmitting function, and box function.

Also, it is possible to select processing print data received from the host computer 102 through operation of the DATA key 210 appearing in FIG. 2. Examples of such a case include a case where print data supplied from the host computer 102 and held in the HDD 122 is outputted. The output form of the print data is selected using the same procedure as the above described one. In this way, an operation flow for processing print data received from the host computer 102 is created.

In the case where the facsimile transmitting function is selected, predetermined processing is performed on data read by the scanner section 132, and the resultant data is transmitted to a designated destination via the FAX IF section 115 in a protocol according to facsimile standards.

Also, it is possible to create an operation flow with the sheet processing function using the finisher section 133, as well as other functions. In this case, a sheet processing key is displayed, and by operating this sheet processing key, the sheet processing function can be selected and advanced settings thereof can be made using the same procedure as in the case where an operation flow using other functions is created. If an operation flow using the sheet processing function is created, sheet processing such as stapling or sorting can be performed on a plurality of printed-out sheets.

Functions that can be used for an operation flow should not be limited to those mentioned in the description of the present embodiment, and an operation flow using combinations of functions which the MFP 100 can have may be created.

As described above, according to the present embodiment, one operation flow can output the same data in a plurality of different output forms, improving user's working efficiency.

Also, input operations on the panel section 134 can create a desired operation flow with ease, making it possible to perform desired work in an efficient manner.

It should be noted that in the above described embodiment, on the flow creation screen shown in FIG. 4, the user creates an operation flow in which the same data is outputted in a plurality of different output forms. Alternatively, operation flows registered in advance may be merged into an operation flow in which the same data is outputted in a plurality of different output forms. Suppose that an operation flow in which “both sides of an original are read in black and white, and the read data is printed” and an operation flow in which “both sides of an original are read in black and white, and the read data is transmitted by electronic mail” are registered in advance. In this example, these two operation flows may be merged into one operation flow in which “both sides of an original are read in black and white, and the read data is printed, and transmitted by electronic mail.” Specifically, a flow merge key is additionally displayed on the flow creation screen 134 shown in FIG. 4. When the user depresses the flow merge key, a list of flows registered in the MFP 100 is displayed, and the user is prompted to select an operation flow to be merged with another flow. It should be noted that operation flows created in the example illustrated in FIG. 4 may be merged. In this case, the flow merge key has to be depressed in a state in which operation flows have been set on the screen in FIG. 4. After the user designates an operation flow to be merged with another flow, the user is prompted to select the operation flow with the designated operation flow is to be merged. Here, when a merge counterpart key is depressed, the CPU 111 searches for operation flows of which parts specifying an operation for inputting data are identical with the corresponding part of the operation flow selected to be merged with another one from the operation flows registered in advance in the MFP 100. A list of operation flows found as a result is displayed on the screen. When the user selects any operation flow from the operation flows which are candidates to be merged with the designated operation flow and depresses the flow merge key, the CPU 111 merges these two operation flows into one operation flow. That is, a plurality of operation flows of which parts specifying an operation for inputting data are the same and of which parts specifying an operation for outputting data are different can be merged into one operation flow. Thus, the user can more easily create an operation flow in which the same data can be outputted in a plurality of different output forms.

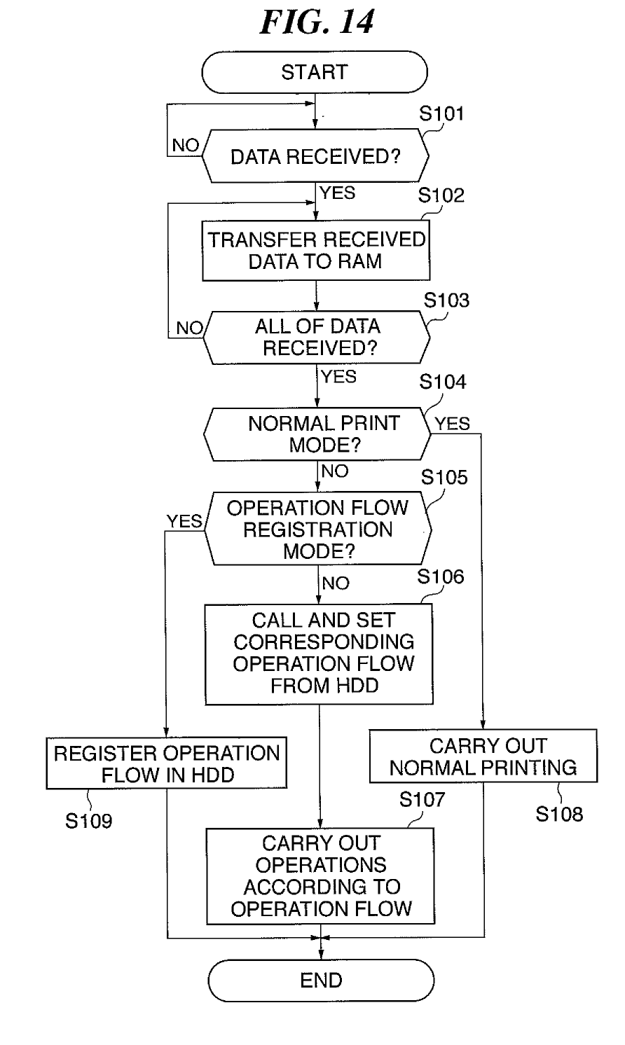

Referring next to FIG. 14, a description will be given of a second embodiment of the present invention. FIG. 14 is a flow chart showing the procedure of a process carried out by an MFP connected to a host computer constituting a data processing apparatus according to the second embodiment. The present embodiment is identical in construction with the first embodiment described above, and in the following description, elements and parts corresponding to those of the first embodiment are designated by the same reference numerals.

In the present embodiment, the host computer 102 has an operation flow creating application capable of creating and registering operation flows for the MFP 100 using an operating procedure similar to that described in the first embodiment. The operation flow creating application acquires information required for creating an operation flow from the MFP 100 through communication between the host computer 102 and the MFP 100. The information required for creating an operation flow is function information indicative of functions which can be incorporated into an operation flow for the MFP 100 and settable items regarding such functions. Operation flow created by the operation flow creating application are transmitted in the form of files to the MFP 100. The MFP 100 receives the files transmitted from the host computer 102 and registers the files in the HDD 122. The files of the operation flows registered in the HDD 122 are managed using their file names.

Also, when necessary, the operation flow creating application can call an operation flow registered in the HDD 122 of the MFP 100 and update the called operation flow. The updated operation flow may be registered in the HDD 122 of the MFP 100. An operation flow is called using a file name of the operation flow.

In creating, registering, and updating an operation flow using the operation flow creating application, the same operating screen (FIGS. 2 to 11) as that in the first embodiment is displayed on a monitor, not shown, of the host computer 102.

A printer driver for the MFP 100 is incorporated in the host computer 102. The printer driver incorporates therein a function of selecting a desired operation flow from among operation flows registered in the MFP 100 and causing the MFP 100 to carry out the selected operation flow.

Settings for selecting an operation flow and carrying out the operation flow are made using the same operating procedure as in the case where an operation flow is called and carried out in the first embodiment described above. In making such settings, the same operating screen (FIGS. 12 and 13) as that in the first embodiment described above is displayed on the monitor of the host computer 102.

An operation flow registered in the HDD 122 of the MFP 100 may be called to be carried out through operation on the panel section 134.

Next, a description will be given of the case where print data created by, for example, the host computer 102 is outputted by the MFP 100.

In this case, the printer driver is activated on the host computer 102. On a print setting screen displayed by the printer driver, it is possible to select outputting the print data according to an operation flow registered in the MFP 100. Responsive to the selection, the printer driver carries out communication with the MFP 100 and acquires file names of all the operation flows registered in the HDD 122. Alternatively, on a print setting screen displayed by the printer driver, the user may instruct the use of an operation flow and enter a user name so that only operation flows associated with the entered user name can be displayed as candidates. The printer driver then displays a selection screen for selecting an operation flow to be carried out on the print data. On this selection screen, a list of the acquired file names of the operation flows is displayed, and the user carries out a predetermined operation to select a file name corresponding to the operation flow to be carried out on the print data. The printer driver transmits the selected file name of the operation flow to the MFP 100.

Upon receiving the file name, the MFP 100 transmits the operation flow corresponding to the operation flow (file in which control information for the operation flow is described) to the host computer 102. Upon receiving the operation flow transmitted from the MFP 100, the printer driver displays a confirmation screen for confirming information indicative of the contents of the received operation flow on the monitor. The confirmation screen is a screen for prompting the user to confirm the contents of the operation flow and also prompts the user to make advanced function settings if the settings have not been made. For example, if a destination address has not been set in the case where the sending function is set, the user is prompted to enter the destination address. Alternatively, advanced settings may be changed via the confirmation screen.

After that, when the user carries out an operation to confirm the displayed contents of the operation flow, the printer driver transmits data including the file name of the confirmed operation flow and the print data to the MFP 100. If, for example, advanced settings have been made, control information therefor is included in the data transmitted to the MFP 100. In this way, the MFP 100 can output the print data by carrying out operations according to the operation flow designated via the host computer 102.

Referring next to a flow chart of FIG. 14, a description will be given of the procedure of a process carried out by the MFP 100 in the case where it has received data from the host computer 102. The procedure in FIG. 14 is carried out by the CPU 111 of the MFP 100.

As shown in FIG. 14, the CPU 111 of the MFP 100 determines whether or not the MFP 100 has received data from the host computer 102 via the USB IF section 116 (step S101) If the MFP 100 has received data from the host computer 102, the CPU 111 transfers the received data to the RAM 113 (step S102). The CPU 111 then determines whether or not the MFP 100 has received all of the data (step S103). If the MFP 100 has not received all of the data, the CPU 111 continues transferring the received data to the RAM 113 until the MFP 100 completely receives all of the data (step S102).

If it is determined in the step S103 that the MFP 100 has received all of the data, the CPU 111 determines whether or not a mode to be carried out is a normal print mode based on a command included in the received data (step S104). The command included in the received data is a command that designates any of the following: a designated operation flow output mode, an operation flow registration mode, and the normal print mode.

If the designated operation output mode is designated, this means that the received data includes at least print data and a file name of an operation flow. Also, the received data may include control information for advanced settings made on the printer driver.

If the operation flow registration mode is designated, the received data includes an operation flow (control information that specifies the operation flow) and a file name of the operation flow.

If the normal print mode is designated, the received data includes only print data.

If it is determined in the step S104 that the mode to be carried out is the normal print mode, the CPU 111 carries out printing based on the received print data (step S108). The CPU 111 then terminates the present process.

If it is determined in the step S104 that the mode to be carried out is not the normal print mode, the CPU 111 determines whether or not the mode to be carried out is the operation flow registration mode based on the command included in the received data (step S105). If it is determined that the mode to be carried out is the operation flow registration mode, the CPU 111 registers an operation flow included in the received data in the HDD 122 via the HDD IF section 121 (step S109) The CPU 111 then terminates the present process.

If it is determined in the step S105 that the mode to be carried out is not the operation flow registration mode, the CPU 111 determines that the mode to be carried out is the designated operation flow output mode. The CPU 111 then calls the operation flow corresponding to the file name from the HDD 122 and sets the called operation flow (step S106). In this case, if control information on advanced settings made on the printer driver is included in the received data, advanced settings of corresponding functions are made based on the control information.

The CPU 111 then carries out operations according to the set operation flow (step S107). For example, it is assumed here that an operation flow is set in which two copies of black-and-white printed output in the output form “1in1” and two copies of color printed output in the output form “2in1” are produced based on the received print data. In this case, the printing function creates black-and-white print data for the output form “1in1” based on the print data held in the RAM 113 and outputs the black-and-white print data to the recording section 131 via the drawing IF section 117. The recording section 131 then produces two copies of black-and-white printed output in the output form “1in1.” Also, the printing function creates color print data for the output form “2in1” based on the print data held in the RAM 113 and outputs the color print data to the recording section 131 via the drawing IF section 117. The recording section 131 then produces two copies of color printed output in the output form “2in1.”

Also, an operation flow using a combination of the printing function, sending function, box function, etc. as in the first embodiment described above may be carried out on the print data.

When the operations according to the operation flow are completed, the CPU 111 terminates the present process.

Although in the present embodiment, operations for creating and registered operation flows for the MFP 100 and selecting registered operation flows are carried out through the host computer 102, the same operations as those operations may be carried out through the server apparatus 101.

As described above, according to the present embodiment, the same effects as those in the first embodiment described above can be obtained. Further, according to the present embodiment, the user can cause the MFP 100 to carry out operations based on an operation flow without directly operating the operating section of the MFP 100.

It is to be understood that the object of the present invention may also be accomplished by supplying a system or an apparatus with a storage medium in which a program code of software, which realizes the functions of any of the above described embodiments is stored, and causing a computer (or CPU or MPU) of the system or apparatus to read out and execute the program code stored in the storage medium.

In this case, the program code itself read from the storage medium realizes the functions of any of the above described embodiments, and hence the program code and the storage medium in which the program code is stored constitute the present invention.

Examples of the storage medium for supplying the program code include a floppy (registered trademark) disk, a hard disk, a magneto-optical disk, a CD-ROM, a CD-R, a CD-RW, a DVD-ROM, a DVD-RAM, a DVD-RW, a DVD+RW, a magnetic tape, a nonvolatile memory card, and a ROM. Alternatively, the program code may be downloaded via a network.

Further, it is to be understood that the functions of any of the above described embodiments may be accomplished not only by executing a program code read out by a computer, but also by causing an OS (operating system) or the like which operates on the computer to perform a part or all of the actual operations based on instructions of the program code.

Further, it is to be understood that the functions of any of the above described embodiments may be accomplished by writing a program code read out from the storage medium into a memory provided on an expansion board inserted into a computer or in an expansion unit connected to the computer and then causing a CPU or the like provided in the expansion board or the expansion unit to perform a part or all of the actual operations based on instructions of the program code.

This application claims the benefit of Japanese Patent Application No. 2005-357870 filed Dec. 12, 2005, which is hereby incorporated by reference in its entirety.

What is claimed is:

1. A data processing apparatus including an output device capable of outputting the same input data in a plurality of different output forms, comprising:
a creating device that creates an operation flow for causing the output device to operate in such a manner as to output the same input data in at least two different output forms, in response to an input operation by a user;
a registering device that registers at least one operation flow created by said creating device;
a selecting device that selects an operation flow designated by the user from among the operation flows registered in said registering device; and
a setting device that sets the operation flow selected by said selecting device for the output device.

2. A data processing apparatus according to claim 1, comprising a display device that displays an operation flow creation operating screen capable of receiving input operations by a user.

3. A data processing apparatus according to claim 1, wherein the output device comprises at least one printing device, and operation flows that can be created for the output device include an operation flow that outputs the same input data in at least two different output forms.

4. A data processing apparatus according to claim 1, wherein the output device comprises a printing device and at least one data processing section, and operation flows that can be created for the output device include an operation flow including an operation in which the same input data is outputted in at least two different output forms by the printing device and an operation in which the same input data is processed by the data processing section.

5. A data processing method applied to a data processing apparatus including an output device capable of outputting the same input data in a plurality of different output forms, comprising:
a creating step of creating an operation flow for causing the output device to operate in such a manner as to output the same input data in at least two different output forms, in response to an input operation by a user;
a registering step of registering at least one operation flow created in said creating step;
a selecting step of selecting an operation flow designated by the user from among the operation flows registered in said registering step; and
a setting step of setting the operation flow selected in said selecting step for the output device.

6. A program for causing a computer to execute a data processing method applied to a data processing apparatus including an output device capable of outputting the same input data in a plurality of different output forms, the program comprising:
a creating module for creating an operation flow for causing the output device to operate in such a manner as to output the same input data in at least two different output forms, in response to an input operation by a user;
a registering module for registering at least one operation flow created by said creating module;
a selecting module for selecting an operation flow designated by the user from among the operation flows registered by said registering module; and
a setting module for setting the operation flow selected by said selecting module for the output device.
